(19) United States
(12) Patent Application Publication
(10) Pub. No.: US 2024/0426270 A1
(43) Pub. Date: Dec. 26, 2024

(54) Ocean Tide Pump For Green Energy Extraction

(71) Applicant: Daniel Farside, Fernley, NV (US)

(72) Inventor: Daniel Farside, Fernley, NV (US)

(21) Appl. No.: 18/339,498

(22) Filed: Jun. 22, 2023

(51) Int. Cl. F03B 13/26

(52) U.S. Cl. CPC F03B 13/262; F05B 2240/97

(57) ABSTRACT

This proposed invention is basically a modified plunger pump designed to harness the pawer of the ocean, in particular the movement of the tide. The really cool pard is that it uses the water to float the weight to the surface something so powerful that we use the same method to get goods across the ocean. The device lets the ocean lift the weight where it is then suspended so the force of gravity can power the pump, which in this case is then used to power a turbine to produce electricity.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A READ-ONLY OPTICAL DISC, AS A TEXT FILE OR AN XML FILE VIA THE PATENT ELECTRONIC SYSTEM

Not Applicable

### STATEMENT REGARDING PRIOR DISCLOSURES BY THE INVENTOR OR A JOINT INVENTOR

Not Applicable

### BACKGROUND OF THE INVENTION

1. “Green Energy” or “Renewable Energy” has come a long way in recent years. Scale, cost, and reliability seem to be the limiting factors for progressing the technology. There are several main themes for the current technology. The top two would be “Solar” and “Wind.” While both are viable and moving the development ahead, they both have large hurdles to clear for mass adoption.

2. Solar is not regularly available and unpredictable in nature. Wind is also not regularly available and unpredictable in nature. These factors have limited mass adoptions of these technologies.

3. The apparatus taught herein would provide regular and reliable energy at scale and with a low cost. By utilizing two powerful forces, the ability to float millions of pounds on the water, and the stored energy that an elevated weight provides. By using the motion of the tide, a massive amount of weight is elevated by the apparatus taught herein. This weight is then elevated also, by the motion of the tide. Having captured this elevation of weight by use of a large plunger pump with two valves the energy can then be converted to electricity by use of a turbine. This would meet a large and growing demand for clean reliable energy at scale.

### BRIEF SUMMARY OF THE INVENTION

1. The two powerful forces the device taught herein utilizes are the ability to float millions of pounds on the surface of water, and the stored energy that this elevated weight provides. By utilizing a plunger pump on a grand scale this energy is captured by the device taught herein. The device is comprised of a large chamber mounted to the ocean floor by means of a concrete foundation. The plunger of this large device is raised by the motion of the tide by utilizing a large float accompanied with a large weight, As the tide rises the inlet valve of the pump chamber is opened to allow water to be sucked or drawn into the chamber. When high tide is achieved and the pump chamber is filled, the two valves that operate the device are closed. This suspends the movement of the plunger in the chamber. As the tide lowers the weight on the plunger grows as the plunger is now carrying an elevated weight caused by the lowering of the tide. Pressure now builds in the chamber. When sufficient pressure has been reached in the chamber, the outlet valve of the chamber is opened to relieve the pressure and drive an electric generating turbine. When low tide is achieved the outlet valve for the chamber is closed completing the cycle for the pump. The inlet valve is then reopened to repeat the cycle.

### BRIEF DESCRIPTION OF THE SEVERAL VIEWS OF THE DRAWINGS

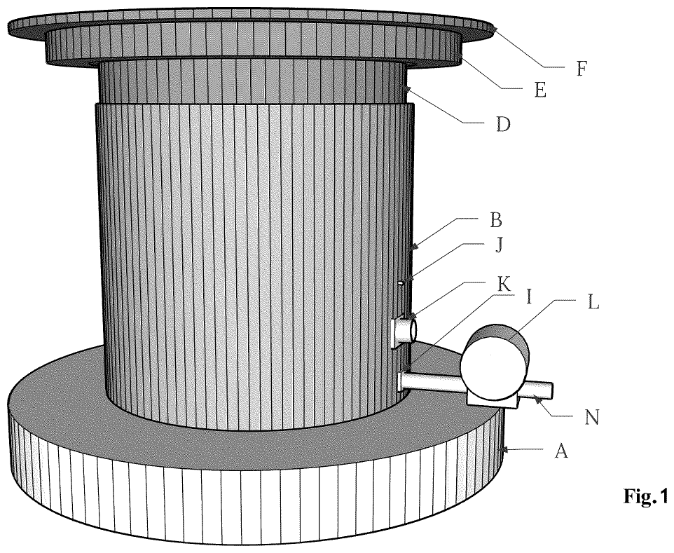

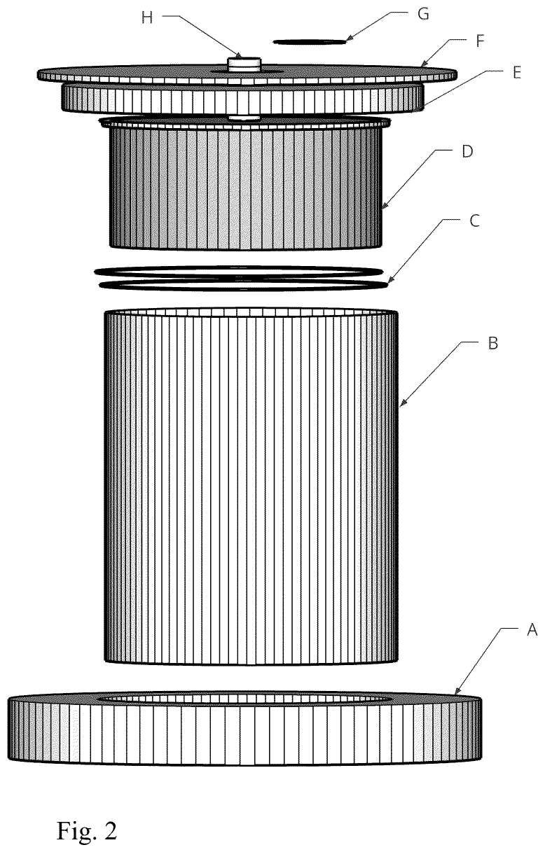

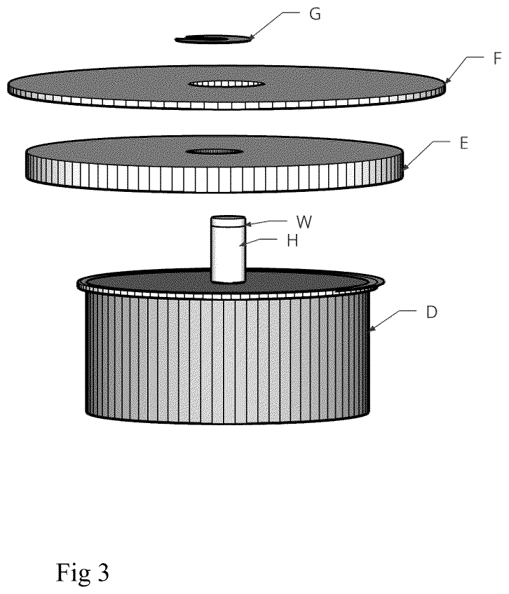

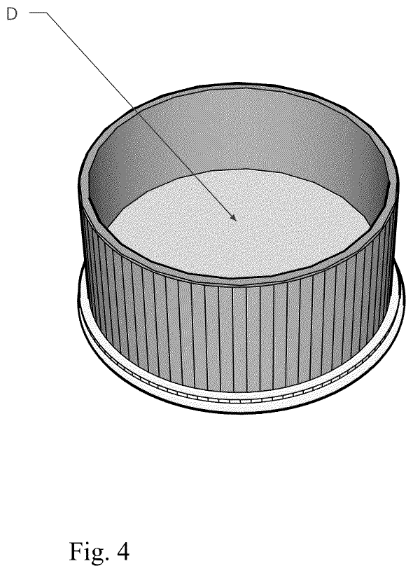

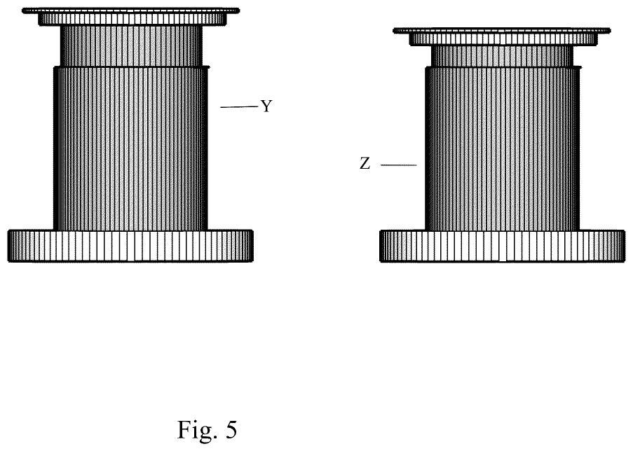

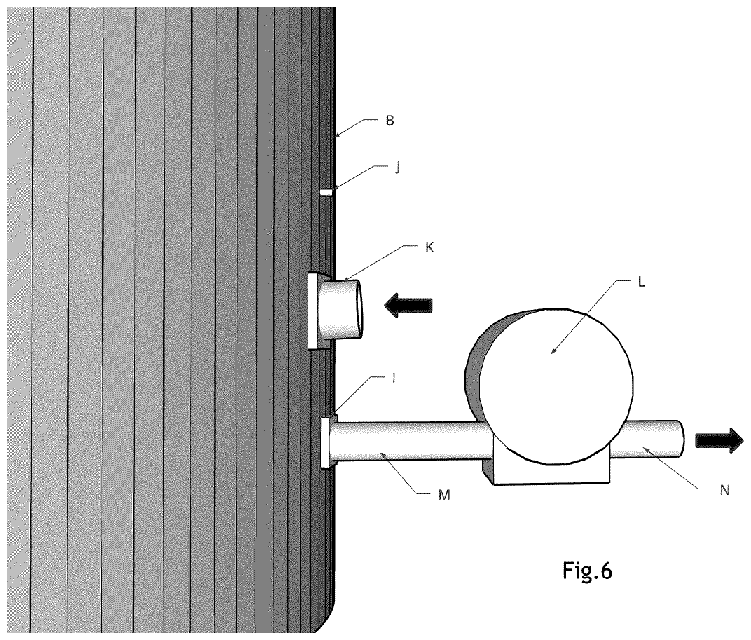

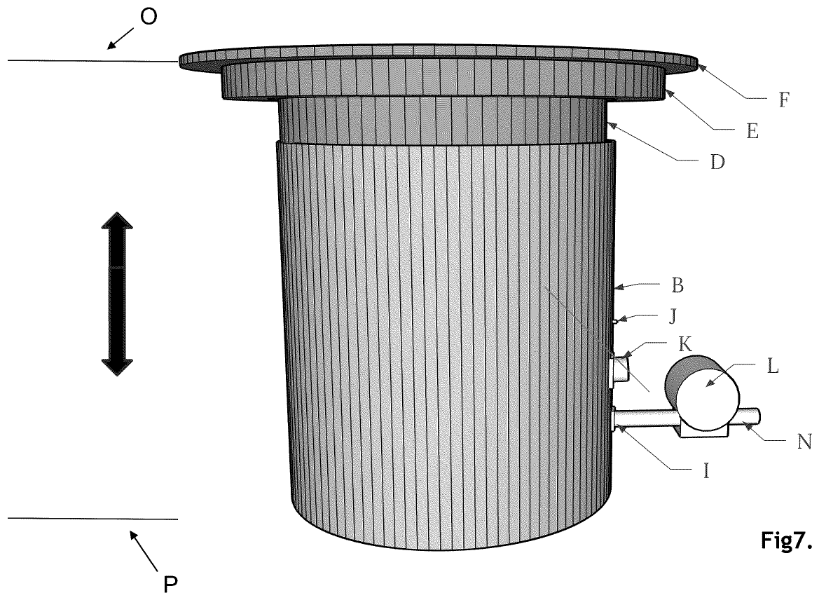

1. FIG. 1. is a view of the device fully assembled with a concrete foundation as it sits on the ocean floor. FIG. 2. is a blow-Figure up of the parts for the assembly of the interior of the pump. FIG. 3 is a blow-up of the plunger assembly of the pump. FIG. 4 is a blow-up of the bottom of the plunger as seen from below. FIG. 5. is a view of the pump assembly in a raised position (Y) and a lowered position (Z.) FIG. 6. is a cutout of the lower portion of the outside of the pump chamber and shows the flow of the water entering and exiting the pump. FIG. 7. depicts a view of the pump as it looks from the ocean floor (not showing the concrete foundation which is buried). The view also delineates the level of water in relation to the pump (O) and the ocean floor (P). The view also depicts the motion of the pump in operation with vertical arrows.

### DETAILED DESCRIPTION OF THE INVENTION

1. The apparatus taught herein differs from a common use of a plunger pump by the method it receives its power. This pump, unlike any other, is powered using a float (E) and a weight (F). The device taught herein is designed to have a massive chamber (B) with a concrete foundation (A) that is designed to sit on the ocean floor where it operates.

2. There is a plunger assembly which consists of the plunger (D) with 2 O-rings (C) and with a stem (H) which is designed to accommodate a float (E), a weight (F) and a retaining ring (G). The retaining ring holds the float and weight in place connected to the top of the plunger.

3. When the pump chamber (B) is mounted to the concrete foundation (A) on the ocean floor submerged in water the plunger is fitted into the chamber. It should be fitted in such a way as to allow for the full vertical motion of the tide (i.e if the tide rises and falls in a 4-foot range the then the pump should be manufactured to allow for the 4-foot movement and still be fitted inside the pump chamber). Since the tide can rise and fall in different ranges based on the location of the pump each pump should be specifically designed for the location it will be used in. If the pump is mass produced, then the installer would have to find a location that would accommodate the full movement of the plunger within the chamber while still being submersed. Likewise, the size of the pump should be variable as well. Depending on someone's budget and the use case they have (i.e. how much power they want to generate or how much they can afford) the pump could vary in size.

4. The chamber of the pump has two valves on the chamber wall. There is an inlet valve (K) and an outlet valve (I). These two valves control the pump. By opening the inlet valve (K) and closing the outlet valve (I) at low tide the pump will suction in water as the tide rises. With a rising tide the float (E) will lift upward in the chamber drawing in water to fill the chamber. At high tide with chamber full of water both valves are shut.

5. This creates a unique circumstance that makes this pump unlike any other. The pump is now loaded with a weight above a chamber full of water. A situation created by the unique operation of a float, a weight and two valves. These few items have created an enormous amount of stored energy. As the tide lowers the floating weight is no longer supported by water. This creates tremendous pressure in the chamber. The pressure is monitored by a pressure sensor (J) and released by opening the outlet valve (I) and forcing the pressurized water through a pipe (M) then through a turbine (L) to produce electric power. The water exits the turbine through a pipe (N) back into the ocean.

6. At low tide the outlet valve (I) is closed, and the inlet valve (K) is opened, and the process repeats itself with each new tide.

1. (canceled)

2. A pump of large scale designed to capture the energy of tidal motion by the use of a floating plunger that rises and falls with the raising and lowering of the tidal motion, inside a chamber, and utilize it to produce high pressure water that is then used to drive a turbine to generate electricity by utilizing two powerful environmentally friendly forces, the first being the stored energy a raised weight provides, and the second being the ability to float large amounts of weight on the surface of the water.
